(19) United States
(12) Patent Application Publication
(10) Pub. No.: US 2003/0177675 A1
(43) Pub. Date: Sep. 25, 2003

(54) Flexible plant identification display cards

(76) Inventor: Willard M. Faulkner, Montgomery, AL (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/100,779

(22) Filed: Mar. 19, 2002

(51) Int. Cl. G09F 1/00

(52) U.S. Cl. 40/124.01; 40/645

(57) ABSTRACT

A plant and flower identification display card includes a preprinted area for displaying photographs and graphics pertaining to plants and flowers and a blank area adjacent thereto which can receive customized self-adhering labels which can be printed at the retail facility and applied to the cards. The blank area has index marks in a preferred embodiment for aligning corners of a pre-sized printable label.

### BACKGROUND OF THE INVENTION

The present invention relates to display cards for displaying graphic and printed information pertaining to plants and flowers in a nursery or garden center and particularly to such a display card which can be custom printed by the retailer.

Retail garden centers and nurseries sell directly to the consumer and, in doing so, provide the consumer with valuable information as to the appearance of the plants, which typically are sold as seedlings which do not represent their mature appearance. Thus, the retailers like to display to the consuming public photographs of the mature plants and flowers in an attractive setting which will assist in the sales of such plants. To be useful for such purpose, it is desirable to print relatively large sized photographs on durable print stock which can remain in a display area for different species plants or flowers. U.S. Pat. No. 4,972,616 discloses a system in which wall charts, cards and individual plant tags are employed for assisting the consumer in selecting plants which are appropriate for given planting areas.

Although plant tags themselves can carry photographs of the mature plants, typically the photographs are relatively small and visible only upon picking up the plant and examining the tag in detail. The display cards, such as Flora-Cards® available from The John Henry Company of Lansing, Mich., are significantly larger and display in a readily visible form photographs of mature plants, as well as planting and care information. The relatively large (7″×11″) display cards which contain such information, including colored photographs, are somewhat expensive due to the multiple color printing process for images on such cards. Thus, for relatively small retailers, the cost of maintaining multiple cards can be somewhat prohibitive. Many garden centers and nurseries have somewhat sophisticated knowledge regarding plants and their care for the local areas in which they are located and, therefore, like to customize their display cards either for such purposes or for providing a store identity associated with the given facility or a chain of facilities. Thus, for their purposes, the customization of large display cards with colored photographs is desired, but printing of such custom cards with, for example, their store name and location can be somewhat expensive.

There exists a need, therefore, for relatively large plant identification or display cards which carry preprinted photographs and graphic information regarding one or more plants or a group of plants thereon and which can accommodate the needs of both relatively large and sophisticated retailers, such as garden centers, as well as the smaller retail centers, both of which would like to provide their customers with customized printed information.

### SUMMARY OF THE INVENTION

The system of the present invention satisfies this need by providing a nursery and plant identification card which includes a preprinted area for displaying photographs and graphics pertaining to plants and flowers and an indexed area spaced adjacent thereto which can receive customized self-adhering labels which can be printed at the retail facility and added to the cards. For such purpose, the cards include a blank area adjacent a printed photograph with the blank area having index marks in a preferred embodiment for aligning corners of a pre-sized printable label which can be printed by the individual retail facilities and applied to the blank indexed area of the cards such that retailers can have custom plant display cards for use in their retail facilities. As a result, both large and small retailers can obtain cost-effective, relatively large plant and flower display cards which can be customized to their particular needs in a cost-effective manner to provide their customers with readily identifiable and usable information.

These and other features, objects and advantages of the present invention will become apparent upon reading the following description thereof together with reference to the accompanying drawings.

### BRIEF DESCRIPTION OF THE DRAWINGS

FIG. 1 is a front elevational exploded view of a pre-printed display card and label to be attached thereto;

FIG. 2 is a front elevational view of the display card and label shown in FIG. 1, shown with the label applied to the card;

FIG. 3 is a greatly enlarged cross-sectional view of the card and label, taken along section lines III-III of FIG. 2; and

FIG. 4 is a printing template for printing labels to be applied to the card shown in FIGS. 1-3.

### DETAILED DESCRIPTION OF THE PREFERRED EMBODIMENT

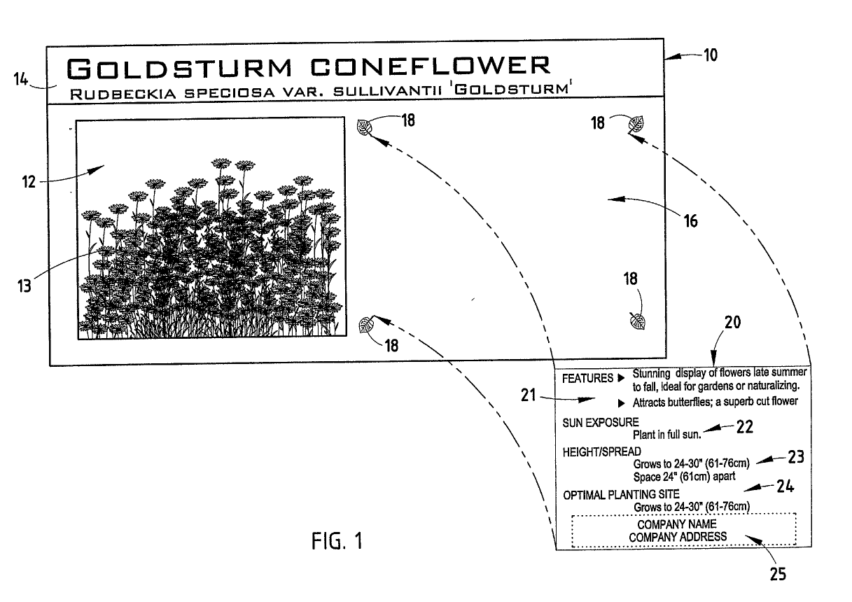

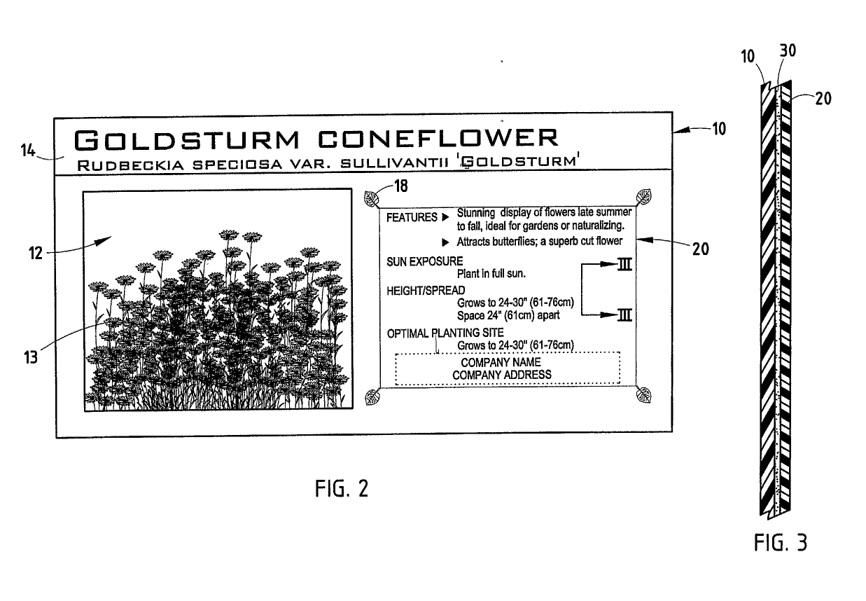

Referring initially to FIG. 1, there is shown a display card 10 embodying the present invention which is adapted to align and receive a separate self-adhering label 20. Card 10 is typically a rather large card having a height of about 7″ and a width of about 11″ to provide a printed area 12 on at least one side thereof of sufficient size such that photographs of plants or flowers, such as represented by indicia 13, can be printed thereon and be readily identified by retail consumers walking through a garden center, nursery or other retail establishment in which the display card is employed. The card may include an upper area 14 for printing thereon a plant identification for a particular plant or groupings of plants or flowers. Illustrated, for example, is a popular coneflower, Rudbeckia Goldstrum (commonly known as “black eyed Susans”, which are also depicted in the indicia 13 printed on, in the preferred embodiment, the left side of the card. The printed area 12 may be relatively large, encompassing an area of approximately 6″ wide by 5″ high and varied as desired. To the right of the printed area 12 and below the printed band 14 is a blank area 16 bordered by four spaced indices 18 for positioning and locating a stick-on label 20 shown as applied in FIG. 2. Indices 18 can be any type of index marks and, in the preferred embodiment shown, small leaves are employed to assist in the alignment for application of label 20 in the blank area 16 of display card 10.

Display card 10 can be made of any desirable, durable material and, in the preferred embodiment, 22 point (0.022″) white polystyrene was used as the stock material onto which the plant identification band 14 is printed as is the photograph 13 and indices 18. The display card 10 is manufactured by a print facility and supplied to retailers together with blank or partially completed labels 20 which can be printed by the retailer in their own facilities using, for example, ink jet or laser printers controlled by conventional microprocessors utilizing a standard word processing or graphics program. Thus, the print facility may provide both the card 10, as well as some form of blank or partially printed label stock for labels 20 and/or partially printed separate labels which can subsequently be custom printed and applied by the retailer. Label 20, for example shown in FIGS. 1 and 2, contains blocks of information such as features of the depicted plant, sun exposure, plant size, and planting site information identified in areas 21-24, respectively, of label 20. Also included on label 20 is an area 25 near the bottom thereof for the retailer to further custom print information, such as its company name, address, logo, telephone number, sales price of the item and other information which can be custom printed on partially printed labels 20 supplied by the print facility supplying display card 10. Areas 21-24 can be left completely blank or blank except for the headings such that the retailer can provide its own information in such areas in addition to the area 25 on label 20.

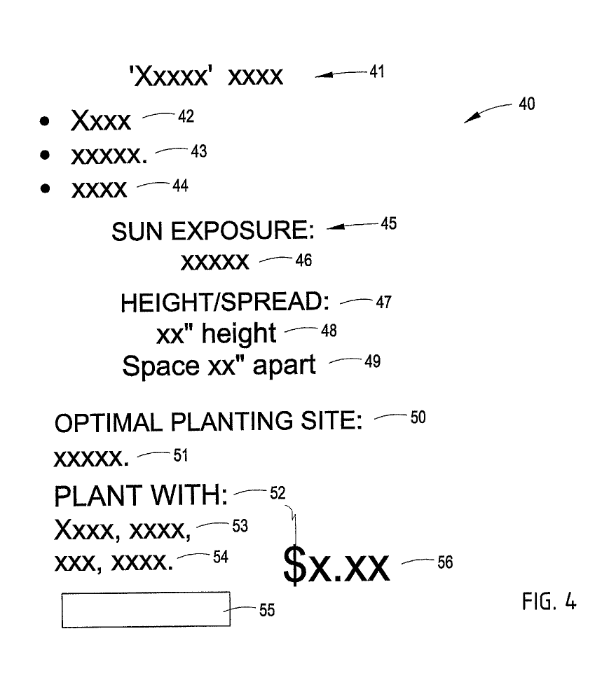

Labels 20 can be printed on a clear polyester film having a peel-away backing of, for example, 65 pound FBK lining material with a permanent acrylic emulsion-type adhesive having a high-tack and a high-sheer strength, such as a commercially available adhesive Model No. TS523. FIG. 3 shows the card 10 with label 20 applied thereto utilizing such an adhesive layer 30 for attachment of the label 20 onto card 10 by aligning the corners of the rectangular label within the boundaries of the index marks 18.

In one embodiment of the invention, labels 20 had a dimension of about 3¼″ in width and 4½″ in height to provide sufficiently large type size to be easily readable by a consumer walking by the significantly sized card 10 and label 20 thereon. The stock for printing labels 20 can be supplied to the retailer from the printer in completely blank or partially printed form. The print supplier of cards 10 can provide templates for the layout of labels 20 via the internet through a web site or via data stored in any digital medium such as magnetic disk, CDs or the like. The selected label stock then can be used by the retailer for completing and printing the labels 20 using their in-house microprocessor and printers.

Typically, the labels 20 will be printed only with black and white type font information, although, if color printers are employed, retail logos in color and other graphics can also be provided, although they will typically be significantly less complicated than the photographs 13 in printed area 12 on card 10. A template 40 for labels 20 is shown in FIG. 4 and may include an area 41 identifying the plant or flower to which the label relates, areas 42-44 for providing particular lines of information pertaining to such plant or flower, an area 45 allowing the light conditions identified by line 46 to be printed thereon, an area 47 defining the mature plant size and spacing in areas 48 and 49. Area 50 defines, for example, the planting site information, and area 52 including lines 53 and 54 for identifying other plants with which the particular plant or flower is optimally associated in a garden. The template 40 includes an area 55 providing store identification, logos and the like, and finally an area 56 identifying the price of the plant. Thus, each of the areas 41-56 of a label 20 can be custom printed by the retailer, and the self-adhesive label 20, once printed, applied to the area 16 of card 10.

Such a system allows great flexibilities for both large and small retailers to customize display cards for their live plants and nursery stock and present to their particular customers in a given geographic area relevant information as to the plants being purchased. Although the materials of the preferred embodiment provide a high quality durable card and label which, once applied, is relatively permanent and appears as an integrally printed card and label, as seen in FIG. 2, other materials and colors of material could likewise be employed. Also, the shape and size of cards 10 and labels 20 can be varied. Thus, the preprinted areas of card 10 can be larger and encompass, for example, the upper two-thirds of the card, leaving the lower section available for a custom label 20. The cards and labels need not be rectangular but could be circular, elliptical, or other geometric or popular shapes for particular applications.

These and other modifications can be made by those skilled in the art without departing from the spirit or scope of the invention as defined by the appended claims.

The invention claimed is:

1. A retail plant and flower display card comprising:
a card having a relatively large surface area divided into at least two sections, with a first section pre-printed with a photograph of at least one of a plant and flower, and a second blank section defined by index marks for receiving a label which can be applied to said second section.

2. The card as defined in claim 1 wherein said card is made from a polymeric material.

3. The card as defined in claim 2 wherein said polymeric material is polystyrene.

4. The card as defined in claim 3 wherein said card has a thickness of about 0.022 inches.

5. The card as defined in claim 4 wherein said card is rectangular and has height and width dimensions of from about 7″ to about 11″, respectively.

6. The card as defined in claim 5 and further including a label shaped to fit within said second section of said card.

7. The card as defined in claim 6 wherein said label is partially pre-printed and has blank areas for adding custom information thereto.

8. The card as defined in claim 1 and further including a label shaped to fit within said second section of said card.

9. The card as defined in claim 8 wherein said label is partially pre-printed and has blank areas for adding custom information thereto.

10. A method of providing custom plant and flower display cards comprising the steps of:
providing a plant display card having a first area with a photograph of at least one of a plant and flower printed thereon and a second blank area defined by index marks, said second area spaced from said first area;
printing a self-adhering label with custom information pertaining to the plant depicted in the photograph of the card; and
applying said label to said second area of said card within said index marks.

11. The method as defined in claim 10 wherein said printing step includes obtaining label information to be printed from an internet source.

12. The method as defined in claim 11 wherein said applying step includes a self-sticking adhesive on a side of the label contacting said card.

13. The method as defined in claim 12 wherein said applying step includes removing a backing paper from the adhesive on said label.

14. A retail plant and flower display card comprising:
a card having a relatively large surface area divided into at least two sections, with a first section pre-printed with a photograph of one of a plant and flower and a second blank section spaced from said first section and including index marks for aligning a label within said second section; and
a label shaped to fit within said second section of the card and including a self-adhering adhesive.

15. The card as defined in claim 14 wherein said card and said label are made from polymeric materials.

16. The card as defined in claim 15 wherein said card material is polystyrene.

17. The card as defined in claim 16 wherein said label material is a polyester film.

18. The card as defined in claim 16 wherein said adhesive is a permanent acrylic emulsion adhesive.

19. The card as defined in claim 18 wherein said label is partially pre-printed and has blank areas for adding custom information thereto.

20. The card as defined in claim 19 wherein said card 18 wherein said card is rectangular and has height and width dimensions of from about 7″ to about 11″, respectively.

21. The card as defined in claim 20 wherein said card has a thickness of about 0.022 inches.

22. The card as defined in claim 14 wherein said index marks are printed leaves at four corners of said second section.
